(19) United States
(12) Patent Application Publication
(10) Pub. No.: US 2026/0340709 A1
(43) Pub. Date: Oct. 29, 2026

(54) DEVICE INTERACTIONS FOR SMART RETAIL APPLICATIONS

(71) Applicant: QUALCOMM Incorporated, San Diego, CA (US)

(72) Inventors: Varun Amar Reddy, San Diego, CA (US); Sony Akkarakaran, Poway, CA (US); Marko Angjelichinoski, San Diego, CA (US)

(21) Appl. No.: 19/115,172

(22) PCT Filed: Aug. 7, 2024
(86) PCT No.: PCT/US2024/041240

§ 371 Date: Mar. 25, 2025

Related U.S. Application Data
(63) Continuation-in-part of application No. 18/469,389, filed on Sep. 18, 2023, now abandoned.

(51) Int. Cl. G06Q 30/0601; G06Q 20/18; G06V 20/52; G07G 1/00; H04W 4/021

(52) U.S. Cl. CPC G06Q 30/0639; G06Q 20/18; G06V 20/52; G07G 1/0036; H04W 4/021

(57) ABSTRACT

This disclosure provides systems, methods, and devices for Electronic Shelf Label (ESL) systems that support cashier-less checkout of products. In a first aspect, a method includes: determining a first location of a cart within an environment based on radio frequency (RF) measurements received from a first wireless device associated with the cart; receiving an association of a second wireless device with the cart and a second location of the second wireless device; determining a first group of products associated with a first region of the environment in a vicinity of the first location; determining a first indication from a sensor corresponding to the first region, the first indication identifying a first potential product selection; and determining whether the first potential product selection meets one or more criteria involving the first location and the second location. Other aspects and features are also claimed and described.

### CROSS-REFERENCE TO RELATED APPLICATIONS

This application claims the benefit of U.S. patent application Ser. No. 18/469,389, entitled, “DEVICE INTERACTIONS FOR SMART RETAIL APPLICATIONS,” filed on Sep. 18, 2023, which is expressly incorporated by reference herein in its entirety.

### TECHNICAL FIELD

Aspects of the present disclosure relate generally to asset tracking and cashier-less checkout of products in a retail environment, and more particularly, to methods and systems for facilitating cashier-less checkout based on user location in a retail environment.

### INTRODUCTION

In general, retail stores use paper labels to display information about products displayed on shelves, such as prices, discount rates, unit costs, origins, or the like. Using such paper labels for the price display has limitations. For example, when there are changes in product information or locations on shelves, the retailer must generate new paper labels and discard old ones. This raises costs for maintenance in both supplies and employee labor. Further, in environmental terms, replacing the labels wastes raw materials such as paper, which adversely affects the protection of the environment. Still further, humans are prone to make mistakes, such as mislabeling a shelf or product or forgetting to take down temporary price changes on certain shelving, which results in shopper frustration.

Electronic shelf label (ESL) devices are electronic devices for displaying price or other relevant information for items on retail store shelves, which may be used in place of paper labels. ESL devices may be attached to a front edge of retail shelving and display a variety of information using display devices, such as Liquid Crystal Displays (LCD). Whenever the information about a product or the location of a product is changed, the ESL device may be programmed with new product information. Thus, the same electronic shelf label can be repeatedly used. The devices or nodes of an ESL system may be equipped with Bluetooth Low Energy (BLE) radios that can be used to track the location of a BLE-enabled device based on the known locations of nearby ESL devices within a retail environment.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Electronic shelf label (ESL) devices may be used in a wireless network to provide information and services to shoppers and retailers (as users of an ESL system). For example, ESL devices operating on a wireless network as part of ESL system may support indoor positioning services to identify the position of ESL devices within a retail environment (e.g., on shelves of a gondola located within a retail store, such as a grocery or department store). As another example, the ESL system may support position location services to identify a position of a user and/or user device within the environment. As still another example, the ESL system may be used to enable cashier-less checkout in the retail environment based on the location of a shopping cart relative to that of the user within the environment. The shopping cart may be equipped with a first wireless device configured to pair with a second wireless device of the user. Once paired, the respective locations of the user and shopping cart (or devices thereof) can be used to determine one or more events, such as the loss or theft of the shopping cart, checkout by the user, and/or termination of use of the shopping cart by the user.

In some embodiments, a server associated with the ESL system may utilize radio frequency (RF) measurements obtained via a wireless network from each wireless device to estimate and correlate locations of the shopping cart and user within the retail environment. For example, the server may request location data including the RF measurements from each device in response to receiving a pairing notification from the first wireless device. Based on the locations of the shopping cart and user (or respective first and second devices thereof that may be correlated together by associating the devices), the server may identify a region of products available for selection by the user in a vicinity of the shopping cart and user (or respective locations thereof). The server may then preemptively activate one or more sensors (e.g., weight sensors on product shelves, shelf cameras associated with the ESL system, and/or surveillance cameras of the retail environment) within the identified region to monitor and detect potential product selections by the user.

In some embodiments, the shopping cart may be further equipped with one or more cameras, which can be mounted on the shopping cart and used to detect the placement of items into a basket of the cart. Computer vision algorithms may be applied to images captured by the camera(s) on the cart to recognize each item placed into the basket. Additionally or alternatively, the cart may include asset trackers or other product sensors that may be used to identify each item (e.g., based on an asset tag or universal product code (UPC) label placed on the item). Also, product data from an Enterprise Resource Planning (ERP) inventory management system may be used to identify the item and associated pricing information. This information may then be used to complete a purchase transaction for the user as part of a cashier-less checkout process. Furthermore, product location information from the ERP system along with images from shelf cameras of the ESL system and surveillance cameras in the environment may provide additional data for determining the location of the shopping cart and user within the environment.

Example embodiments provide systems and methods for enabling cashier-less checkout in a retail environment based on the relative locations of shopping carts and users (or respective wireless devices thereof) within the environment.

In one aspect of the disclosure, a method includes: determining, by a server, a first location of a cart within an environment based on radio frequency (RF) measurements received via a wireless network from a first wireless device associated with the cart; receiving, by the server via the wireless network, an association of a second wireless device with the cart and a second location of the second wireless device; determining, by the server, a first group of products associated with a first region of the environment in a vicinity of the first location; determining, by the server, a first indication from a sensor corresponding to the first region, the first indication identifying a first potential product selection; and determining, by the server, whether the first potential product selection meets one or more criteria involving the first location and the second location.

In an additional aspect of the disclosure, an apparatus includes at least one processor and a memory coupled to the at least one processor. The at least one processor is configured to perform operations including: determining a first location of a cart within an environment based on radio frequency (RF) measurements received via a wireless network from a first wireless device associated with the cart; receiving, via the wireless network, an association of a second wireless device with the cart and a second location of the second wireless device; determining a first group of products associated with a first region of the environment in a vicinity of the first location; determining a first indication from a sensor corresponding to the first region, the first indication identifying a first potential product selection; and determining whether the first potential product selection meets one or more criteria involving the first location and the second location.

In an additional aspect of the disclosure, an apparatus includes an at least partially enclosed volume to hold products selected by a user; and a first wireless device including a memory and at least one processor coupled to the memory. The at least one processor is configured to perform operations comprising: determining a first location of the first wireless device based on radio frequency (RF) measurements of wireless signals exchanged between the first wireless device and one or more access points of a wireless network; determining a second location of a second wireless device associated with the user, based on additional RF measurements of signals exchanged between the first wireless device and the second wireless device; and transmitting, to a server via the wireless network, the first location of the first wireless device, an association of the second wireless device with the first wireless device, and the second location of the second wireless device.

In an additional aspect of the disclosure, an apparatus includes at least one processor and a memory coupled to the at least one processor. The at least one processor is configured to perform operations including: determining a first location of a user based on radio frequency (RF) measurements of wireless signals received from one or more access points of a wireless network; determining a second location of a cart, based on additional RF measurements of signals received from a wireless device associated with the cart; and transmitting, to a server via the wireless network, the first location of the user in association with the second location of the cart.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

Devices, networks, and systems may be configured to communicate via one or more portions of the electromagnetic spectrum. The present disclosure describes certain aspects with reference to certain communications technologies, such as Bluetooth or Wi-Fi. However, the description is not intended to be limited to a specific technology or application, and one or more aspects described with reference to one technology may be understood to be applicable to another technology. Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus, and methods described herein may be applied to other communications systems and applications than the particular examples provided.

For example, the described implementations may be implemented in any device, system, or network that is capable of transmitting and receiving RF signals according to any of the wireless communication standards, including any of the IEEE 802.11 standards, the IEEE 802.15.1 Bluetooth® standards, Bluetooth low energy (BLE), code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, 5G New Radio (5G NR), 6G, or other known signals that are used to communicate within a wireless, cellular, or internet of things (IOT) network, such as a system utilizing 3G, 4 5G, or 6G technology, or further implementations thereof.

In various implementations, the techniques and apparatus may be used in wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably and may refer to a collection of devices capable of communicating with each other through one or more communications techniques.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, or packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.).

Implementations may range from chip-level or modular components to non-modular, non-chip-level implementations and further to aggregated, distributed, or original equipment manufacturer (OEM) devices or systems incorporating one or more described aspects. In some settings, devices incorporating described aspects and features may also include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, or constitutions.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well-known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the below description and examples use the term “device” to describe various aspects of the disclosure, the term “device” is not limited to a specific configuration, type, or number of objects. As used herein, an apparatus may include a device or a portion of the device for performing the described operations.

As used herein, including in the claims, the term “or,” when used in a list of two or more items, means that any one of the listed items may be employed by itself, or any combination of two or more of the listed items may be employed. For example, if a device is described as containing components A, B, or C, the device may contain A alone; B alone; C alone; A and B in combination; A and C in combination; B and C in combination; or A, B, and C in combination.

Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

Also, as used herein, the term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes .1, 1, 5, or 10 percent.

Also, as used herein, relative terms, unless otherwise specified, may be understood to be relative to a reference by a certain amount. For example, terms such as “higher” or “lower” or “more” or “less” may be understood as higher, lower, more, or less than a reference value by a threshold amount.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1A is a block diagram illustrating a perspective view of an example Electronic Shelf Label (ESL) system within a retail environment according to some embodiments of this disclosure.

FIG. 1B is a block diagram of an overhead view of the ESL system of FIG. 1A according to some embodiments of the disclosure.

FIG. 1C is a diagram illustrating an example ESL device in the ESL system of FIGS. 1A and 1B according to some embodiments of the disclosure.

FIG. 2A is a perspective view of a gondola including shelves with ESL devices for displaying information regarding products available for selection by a user within a retail environment according to some embodiments of the disclosure.

FIG. 2B is a top-down view of an example product region corresponding to an aisle between two gondolas within the retail environment of FIG. 2A according to some embodiments of the disclosure.

FIG. 3 is a timing diagram illustrating time division multiplexing for communicating with multiple ESL devices according to some embodiments of the disclosure.

FIG. 4 is a block diagram illustrating an example of an ESL device according to some embodiments of this disclosure.

FIG. 5 is a signaling diagram of an example communication flow between different devices of an ESL system for enabling cashier-less checkout in a retail environment based on a location of a shopping cart relative to that of a user according to some embodiments of this disclosure.

FIG. 6 is a signaling diagram of another example communication flow between different devices of an ESL system for detecting spurious product placement within a shopping cart associated with a user according to some embodiments of this disclosure.

FIG. 7 is a flow chart of an example method for enabling cashier-less checkout in a retail environment according to some embodiments of this disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support indoor positioning of user devices or objects within a retail environment (such as a grocery or department store). The terms “retail environment” and “environment” are used interchangeably herein to refer broadly and inclusively to any physical space or layout (e.g., within a physical “brick-and-mortar” retail store) where a retail business operates and provides products or services to customers In some embodiments, an Electronic Shelf Label (ESL) system including multiple ESL devices may be deployed within different product regions throughout the retail environment. The ESL system may utilize the ESL devices in conjunction with a wireless network and network infrastructure of the environment to monitor product inventory, track the location of assets (e.g., shopping carts and other equipment), and provide indoor positioning and navigation services for users (e.g., shoppers) within the environment.

Particular implementations of the subject matter described in this disclosure may be implemented to realize one or more of the following potential advantages or benefits. In some aspects, the present disclosure provides indoor positioning techniques for ESL systems that may be particularly beneficial in smart retail applications. A smart retail application may involve, for example, the use of a “smart cart” with wireless communication capability to enable a cashier-less checkout of product items by a shopper in a retail environment. The smart cart in this example may be a shopping cart equipped with a wireless device configured to pair with a user's wireless device (e.g., a smart phone or other mobile device). The terms “shopping cart” and “cart” are used interchangeably herein to refer broadly and inclusively to any movable device or tool having an at least partially enclosed volume (e.g., a basket or storage area having at least one side structure defining the volume for collecting items) for collecting and temporarily storing items intended for purchase by a user (or shopper) while navigating a physical retail store. Such a basket device or tool may include, for example and without limitation, motorized or non-motorized (e.g., human-propelled) shopping carts with wheels and handheld shopping baskets. Once paired, location data including radio frequency (RF) measurements obtained from each wireless device may be used by a server of the ESL system to correlate an estimated location of the shopping cart with that of the user within the environment. The relative (or correlated) locations of the shopping cart and user within the environment may be used to detect one or more events, such as the loss or theft of the shopping cart, checkout by the user, and/or termination of use of the shopping cart by the user.

In some embodiments, the location information may be used by the server to identify a region of products available for selection by the user in a vicinity of the shopping cart and the user (or respective devices thereof) within the retail environment. In some implementations, the product region may be identified using a combination of the RF measurements received from each wireless device and information pertaining to the layout of products or product regions and associated devices within the retail environment. Such information may be obtained from an Enterprise Resource Planning (ERP) inventory management system associated with the retail environment. The server may preemptively activate one or more sensors in the identified region to monitor and detect potential product selections by the user. Such sensors may include, for example, weight sensors, cameras installed on product shelves, and/or cameras associated with a surveillance system of the retail environment. Additionally or alternatively, one or more cameras or other sensors mounted on the shopping cart (along with computer vision software with object detection capability) may be used to detect and identify one or more items selected by the user and placed into a basket of the shopping cart. In some implementations, for example, the shopping cart may include asset trackers or other product sensors that may be used to identify each item, e.g., based on an asset tag or universal product code (UPC) label placed on the item and readable by the cart's sensors. Product data, such as pricing information, obtained from the ERP system may also be used to complete a cashier-less checkout by the user for the purchase of the items.

In some embodiments, the RF measurements obtained from each device may be combined with visual data obtained from one or more cameras (e.g., one or more shopping cart cameras, shelf cameras, and/or surveillance cameras) to aid the server in estimating the respective locations of the shopping cart and user within the environment. For example, the visual data may be used to narrow down the location of the shopping cart and/or the location of the user to a particular area of the environment corresponding to a field of view of the camera(s) and thereby improve an accuracy of the location estimation and/or region identification. However, unlike conventional approaches that rely primarily, if not exclusively, on video surveillance to enable smart retail applications, the visual information obtained from a camera in the embodiments of the present disclosure supplements the RF measurements used to enable cashier-less checkout for a user based on the location of the user and the user's shopping cart within a retail environment. Furthermore, the privacy concerns typically associated with such conventional approaches may be mitigated by physically orienting any camera mounted on the cart to limit the camera's field of view to only the basket area of the cart. Additionally, privacy concerns may be addressed by applying computer vision techniques, such as segmentation and segmentation masking (as implemented by the server or in the cameras themselves), to the images captured by each camera (including each of the shelf and surveillance cameras).

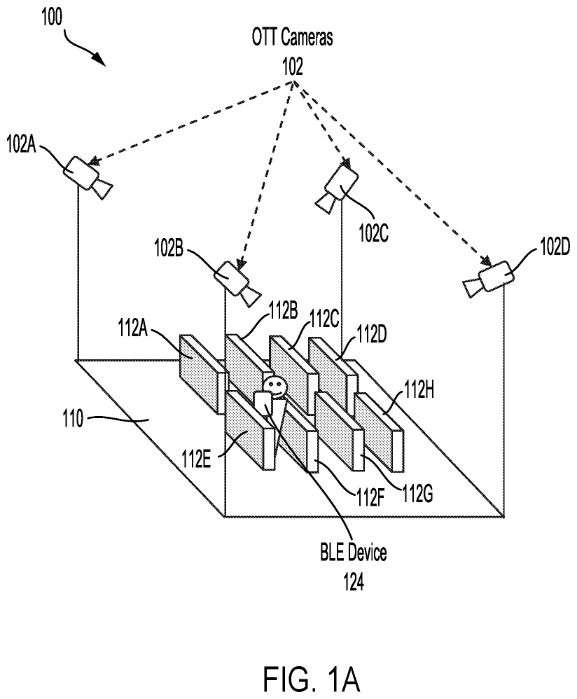

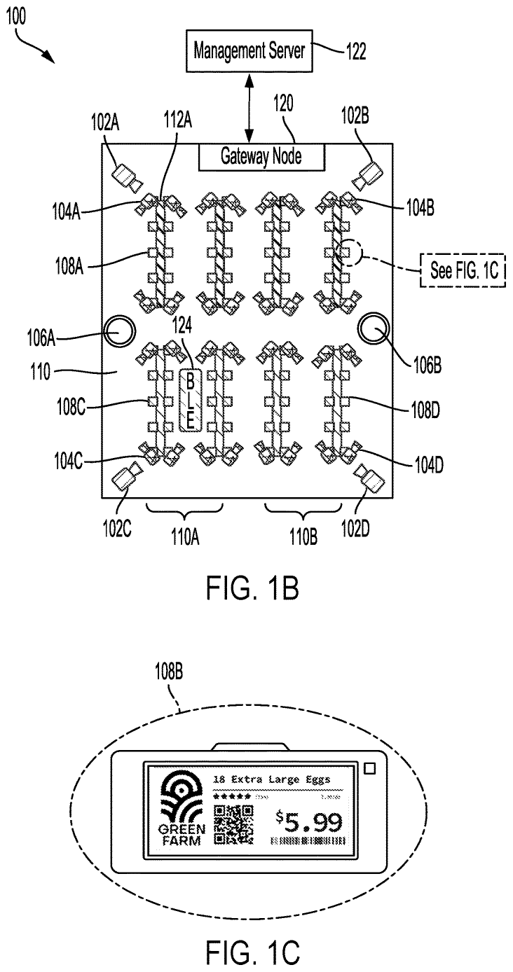

FIG. 1A is a block diagram illustrating a perspective view of an example ESL system 100 within a retail environment according to some embodiments of this disclosure. As shown in FIG. 1A, the ESL system 100 may be deployed across multiple aisles of gondolas 112A-112H within a retail environment 110. The retail environment 110 may include, for example, a retail floor space of a retail store. As will be described in further detail below, each of the gondolas 112A-112H may include one or more shelves to which a plurality of ESL devices are attached. The ESL devices may be used to display pricing and/or other information related to products located on the shelves. Each of the ESL devices may include one or more wireless radios for transmitting and receiving information over a wireless network associated with the retail store. Such radios may support any of various wireless communication standards and technologies. Examples of such technologies include, but are not limited to, Wi-Fi, Bluetooth, Bluetooth Low Energy (BLE), 5G NR, ultra-wideband (UWB), and other RF technologies.

In some implementations, cameras may be installed on or near the shelves at the ends of the gondolas 112A-112H to capture different views of the aisles and/or other pathways in the areas surrounding the gondolas 112A-112H. Additionally, over-the-top (OTT) cameras 102A-102D (or “OTT cameras 102” collectively) may be positioned at different overhead locations throughout the retail store to capture larger regions of the retail environment 110. In some implementations, the OTT cameras 102 may be part of a separate surveillance system of the retail store used for security and monitoring purposes.

In some embodiments, images and/or video captured by the OTT cameras 102 and/or those captured by the shelf cameras on the gondolas 112A-112H may be utilized as visual channel state information (CSI) to reduce, if not resolve, any errors or ambiguities detected in the position of a BLE device 124 within the retail environment 110. The BLE device 124 may be, for example, a mobile device of a user (e.g., a customer or employee of the retail store). The BLE device 124 may be equipped with a BLE radio for receiving low power beacon signals transmitted by the ESL devices attached to the gondolas 112A-112H. As will be described in further detail below with respect to FIG. 1B, radio frequency (RF) measurements of the signals captured by the BLE device 124 along with the visual CSI from the OTT cameras 102 and/or the shelf cameras may be provided to a management server of the ESL system 100 for monitoring or tracking the position of the BLE device 124 as it (and the user) traverses different areas of the environment 110.

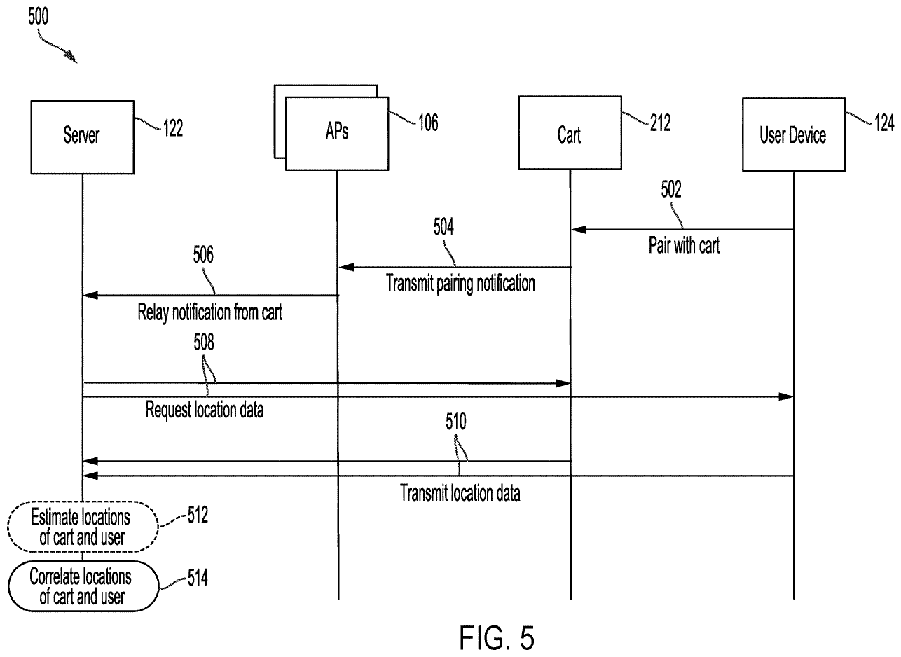

FIG. 1B is a block diagram of an overhead view of the ESL system 100 of FIG. 1A according to some embodiments of the disclosure. As shown in FIG. 1B, the ESL system 100 may further include a management server 122 that is integrated with or coupled to a gateway node 120. The management server 122 may include at least one processor coupled to a memory, in which the at least one processor is configured to execute computer program code stored on a computer-readable medium to cause the management server 122 to perform operations related to managing operation of ESL devices 108A-108D, access points (APs) 106A and 106B, the gateway node 120, and/or other components within the ESL system 100. For example, the management server 122 may perform operations relating to an indoor positioning service for cashier-less checkout by the user based on the location of the user (and the BLE device 124) within the retail environment 110 relative to that of a shopping cart associated with the user, as will be described in further detail below with reference to FIGS. 5-7.

The gateway node 120 may communicate with access point (AP) 106A and access point (AP) 106B. Although only two APs are shown in the example system, fewer or more APs may be included in the ESL system 100. The APs 106A and 106B may communicate through a first communication network, either wired or wireless, with the gateway node 120. The APs 106A and 106B may also communicate through a second communication network with the ESL devices 108A-108D. In some embodiments, the first and second communication networks may be different networks. For example, the first communication network (e.g., between the AP 106A and the gateway node 120) may be a Wi-Fi network, and the second communication network (e.g., between the AP 106A and the ESL device 108A) may be a Bluetooth network. In some implementations, the APs 106A and 106B may be part of a wireless infrastructure of the retail environment 110 that supports one or more wireless technologies (e.g., Wi-Fi, Bluetooth, BLE, and/or UWB). The infrastructure may be utilized by the ESL system 100 for enabling the indoor positioning and location-based cashier-less checkout techniques disclosed herein.

In some embodiments, each of the APs 106A and 106B may communicate with a subset of the ESL devices 108A-108D located in a geographic area assigned to that AP, e.g., based on a location of the AP relative to each ESL device and/or a signal coverage area of the AP. For example, the retail environment 110 may be divided into two equally-sized geographic areas that each cover approximately half of the total retail environment 110. The AP 106A may be assigned to a geographic area 110A, and the AP 106B may be assigned to a geographic area 110B. Accordingly, the AP 106A may communicate with ESL device 108A and ESL device 108B located in the geographic area 110A, and the AP 106B may communicate with ESL device 108C and ESL device 108D located in the geographic area 110B.

Bluetooth technology provides a secure way to connect and exchange information between electronic devices, such as smartphones, other cellular phones, headphones, earbuds, smartwatches, laptops, wearables, and/or shelf labels. Bluetooth communications may include establishing wireless personal area networks (PANs) (also referred to as “ad hoc” or “peer-to-peer” networks). These ad hoc networks are commonly called “piconets.” Each device may belong to multiple piconets. Multiple interconnected piconets may be called scatternets. A scatternet may be formed when a member of a first piconet elects to participate in a second piconet. In the example of FIG. 1B, the ESL devices 108A and 108C may be in a piconet with the AP 106A.

Because many of the services offered over Bluetooth can expose private data or allow the connecting party to control the connected device, Bluetooth networks may have devices first establish a “trust relationship” before they are allowed to communicate private data to one another. This trust relationship may be established using a process referred to as “pairing,” in which a bond is formed between two devices. This bond enables the devices to communicate with each other in the future without further authentication. Thus, the ESL device 108A in FIG. 1B may be bonded in such a manner to the AP 106A. The pairing process may be triggered automatically each time the device is powered on or moved within a certain distance of another Bluetooth device. Pairing information relating to current and previously established pairings may be stored in a paired device list (PDL) in the memory of the Bluetooth device, such as the ESL device 108A and/or the AP 106A. This pairing information may include a name field, an address field, a link key field, and other similar fields (such as “profile” type) useful for authenticating the device or establishing a Bluetooth communication link. The pairing information may allow the ESL device 108A to reconnect to the AP 106A automatically when, for example, power loss causes the ESL system 100 to reset.

A Bluetooth “profile” describes general behaviors through which Bluetooth-enabled devices communicate with other Bluetooth devices. For example, the hands free profile (HFP) describes how a Bluetooth device (such as a smartphone) may place and receive calls for another Bluetooth device, and the Advanced Audio Distribution Profile (A2DP) describes how stereo-quality audio may be streamed from a first Bluetooth device (such as a smartphone) to another Bluetooth device (such as an earbud). The ESL devices 108A-108D may be configured with an ESL Profile compliant with the Electronic Shelf Label Profile Specification v 1.0 dated Mar. 28, 2023, which is incorporated by reference herein. The ESL Profile may specify how the AP 106A may use one or more ESL Services exposed by the ESL device 108A.

In some embodiments, the management server 122 may include or be coupled to a database that stores and manages product information regarding products displayed in a retail store or distribution warehouse. The database may store a variety of information used by the management server 122 during the operation of the store in addition to the product information. Such information may include, for example, product information regarding products displayed in the store as well as the location and other relevant information associated with each component of the ESL system 100 (including each of the ESL devices 108A-108D and the APs 106A and 106B). In some implementations, the database may be part of an Enterprise Resource Planning (ERP) and inventory management system for managing inventory (e.g., products) and other assets (the ESL devices 108A-108D and other components of the ESL system 100) in the retail environment 110. The management server 122 may be implemented separately from or as a part of the ERP system.

The management server 122 may generate and transmit command messages to the ESL devices 108A-108D via the first communication network described above. The command messages may be used by the management server 122 to carry out various functions in the ESL system 100, such as the synchronization, updating, and alteration of product information displayed on the ESL devices 108A-108D. The management server 122 may obtain the product information from a product database provided for the ESL devices 108A-108D. For example, the management server 122 may access the database of the ERP system described above for identification information relating to the ESL devices 108A-108D in connection with product information to be displayed on a corresponding one of the ESL devices 108A-108D.

A command message created by the management server 122 (e.g., a product-information change message or a management-information acquisition message) can be transferred to the gateway node 120 using a communication scheme suitable for the gateway node 120. The command message may be converted into a packet configured according to the communication scheme and the configured packet may be transferred to the gateway node 120. Furthermore, the management server 122 may receive a reception acknowledgement message sent from the gateway node 120 using the communication scheme. In some cases, the acknowledgement message may be first converted into a message format suitable for reception by the management server 122 before being transferred by the gateway node 120.

In some embodiments, the command messages transmitted by the management server 122 via the gateway node 120 may include various commands directed to different devices in the ESL system 100 for detecting and enabling a cashier-less checkout of product selections by the user of the BLE device 124 based on the location of the user (or BLE device 124) relative to that of a shopping cart associated with the user within the retail environment 110. The shopping cart may be equipped with a wireless device configured to pair with the BLE device 124. Once paired, location data including radio frequency (RF) measurements obtained from the BLE device 124 and the wireless device associated with the cart may be used by the management server 122 to correlate a location of the shopping cart with that of the user (and the BLE device 124) within the environment 110. The management server 122 may use the correlated locations to identify a corresponding region of products available for selection by the user within the environment. The management server 122 may also preemptively activate one or more sensors in the identified region to monitor and detect potential product selections by the user. Such sensors may include, for example, weight sensors on a corresponding shelf of one or more of the gondolas 112A-112H corresponding to the region and/or one or more cameras, such as one or more of shelf cameras 104A-104D and/or OTT cameras 102, having a field of view covering the region. The management server 122 may detect the selection of one or more products by the user based on information received from the activated sensor(s).

In some implementations, the relative locations of the shopping cart and the user within the environment 110 may be monitored and used by the management server 122 to detect various other events. Examples of such events include, but are not limited to, the loss or theft of the shopping cart, the initiation of a checkout process by the user to purchase the selected items (e.g., based on an indication that the user is ready to checkout when the locations of the shopping cart and user are determined to be within a checkout area near an entrance/exit of the store), the termination of use of the shopping cart by the user (e.g., after the checkout process has been initiated and the user unpairs the BLE device 124 from the cart), and/or the accidental or spurious placement of items into the cart by other users, as will be described in further detail below.

Examples of commands that may be sent by the management server 122 via the gateway node 120 to enable various features of the location-based cashier-less checkout techniques disclosed herein include, but are not limited to, commands to activate one or more cameras or other sensors within an identified product region for detecting potential product selections by the user and commands directing the BLE device 124 of the user and/or the wireless device on the shopping cart to report RF-based positioning measurements for monitoring the relative location of each device within the environment. The positioning measurements may include, for example, RF measurements of wireless signals exchanged between each device and the APs 106A and 106B, which may be used to estimate the corresponding locations of the user and the shopping cart within the environment 110. Such measurements may also include range measurements of wireless signals exchanged between the BLE device 124 and the wireless device on the cart. The range measurements may be used to verify whether the user is located sufficiently close to (e.g., within a threshold distance of) the shopping cart when items are placed into the. This may help validate whether products placed in the cart were actually selected and placed by the user and not accidentally placed by another user, e.g., another shopper located in the same aisle as the cart (and potentially associated with a different shopping cart). In some embodiments, the management server 122 may also send commands directing one or more of the shelf cameras 104A-104D and/or the OTT cameras 102A-102D to provide visual information (e.g., images and/or video sequences) that the management server 122 may use to supplement the RF measurements for estimating and monitoring the respective locations of the shopping cart and the user within the environment 110, as will be described in further detail below.

Although only one gateway node 120 is shown in the ESL system 100, there may be several such gateway nodes communicating with the management server 122. Each gateway node 120 analyzes data received from the management server 122, confirms the presence or absence of a message or data to be sent to one or more of the ESL devices 108A-108D, and then sends the confirmed message or data to the appropriate ESL device. For example, the gateway node 120 may configure a message, which is to be sent to the ESL device 108A, into a packet according to a communication scheme and send the configured packet to the ESL device 108A through commanding the AP 106A to transmit the packet. Furthermore, the gateway node 120 may transfer a reception acknowledgement message received from the ESL device 108A through the AP 106A to the management server 122.

Each of the ESL devices 108A-108D may include a display, such as a Liquid Crystal Display (LCD), for displaying data concerning products located on a shelf to which the corresponding ESL device is attached. The information displayed by each of the ESL devices 108A-108D may be received from the gateway node 120. The ESL devices 108A-108D may change price information or be activated or inactivated while communicating with the gateway node 120. A store manager may send the management server 122 a command concerning the synchronization between a product and a specified ESL device and/or a command for the correction of information regarding a product assigned to the particular ESL device. An example of the ESL device 108B is shown in FIG. 1C with a display device for displaying product information, such as a product description, a product image, a product price, a product barcode, a product rating, a product Stock Keeping Unit (SKU), and/or a product link (e.g., a URL or QR code).

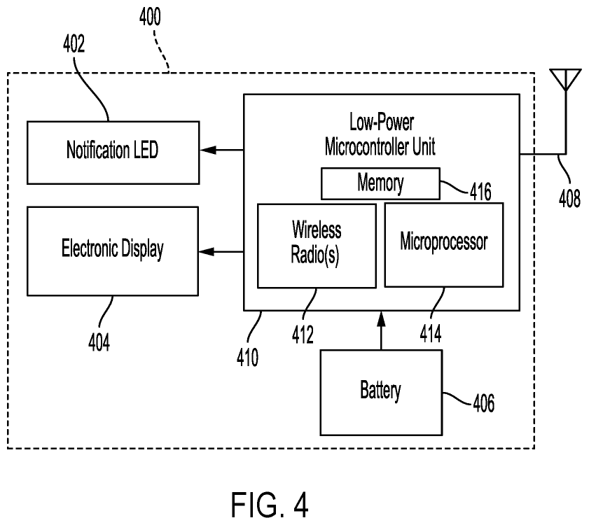

Each of the ESL device 108A-108D may be configured with a memory and microprocessor for performing various operations. An example of such a configuration for the ESL device 108A is shown in FIG. 4, as will be described in further detail below.

In some embodiments, visual information obtained from the shelf cameras 104A-104D and/or the OTT cameras 102 may be used to augment the indoor positioning and product tracking capabilities of the ESL system 100. For example, the shelf cameras 104A-104D may be positioned with a field of view that captures one or more shelves of one or more of the gondolas 112A-112H. The shelf cameras 104A-104D may be used to assist in tracking stock levels and/or identifying items picked by users while in the environment. Furthermore, the OTT cameras 102, which may be part of a separate surveillance system of the retail environment 110, may be positioned with different fields of view capturing large areas of the retail environment 110. Object recognition models or systems may be applied to the image frames or other visual information received from the cameras 102A-102D and/or 104A-104D to determine a presence of, or a count of, objects and/or people in the field of view of each camera.

The OTT cameras 102A-102D may be used to support the determination of the positions of the ESL device 108A-108D, the BLE device 124, and/or other devices within the retail environment 110. As described above, the BLE device 124 may be a mobile device that a user carries while moving through the retail environment 110. As the user traverses with the BLE device 124, the BLE device 124 may communicate with the ESL devices 108A-108D, for example, by receiving identification information from the ESL devices 108A-108D. The location of the ESL devices 108A-108D may be determined by identifying a location of the BLE device 124 from the camera image frames at the time the BLE device 124 receives signals, and/or the strength of the signals, received from the ESL devices 108A-108D.

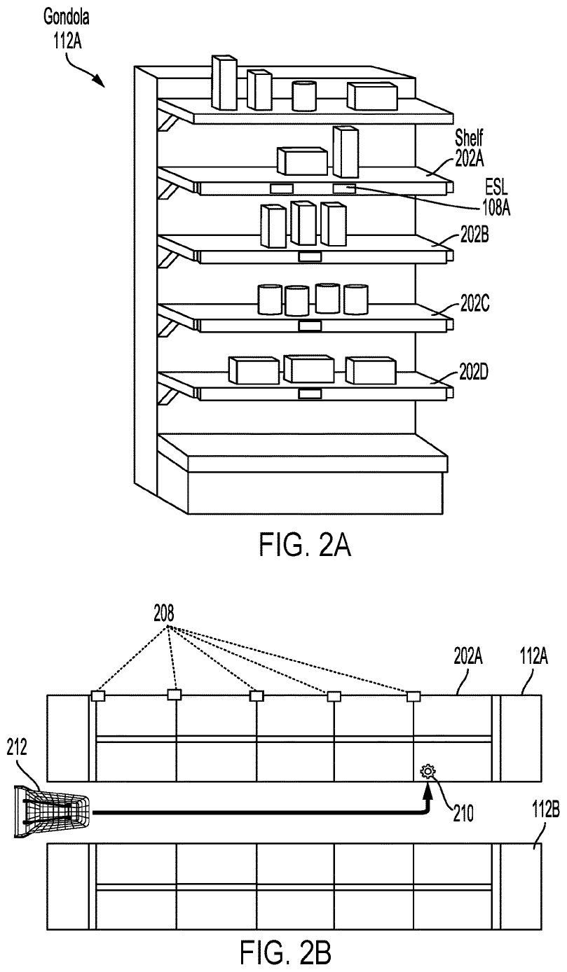

As described above, the retail environment associated with the ESL system may include ESL devices organized on gondolas and shelves. One example illustration of such an arrangement is shown in FIG. 2A. FIG. 2A is a perspective view of a gondola with ESL devices according to some embodiments of the disclosure. The gondola 112A may include multiple shelves 202A-202D at different vertical levels from a floor. ESL devices may be attached to the shelves 202A-202D. For example, ESL device 108A may be attached to shelf 202A to display information regarding products stocked on shelf 202A in the vicinity of the ESL Device 108A.

The ESL devices may provide information to a shopper or store employee operating in the environment, such as to provide information regarding products and/or assist with location determination of products or the user. FIG. 2B is a top-down view of a retail environment with Electronic Shelf Label (ESL) devices accessible to a user according to some embodiments of the disclosure. As shown in FIG. 2B, gondola 112A may include a dense deployment of ESL devices 208 (including the ESL device 108A of FIG. 2A) in which adjacent ESL devices may be uniformly spaced along the shelf 202A. Additional ESL devices may be similarly positioned along other shelves of gondola 112A and along the shelves of gondola 112B.

A user pushing a shopping cart 212 through the aisle between the gondolas 112A and 112B may use the ESL devices 208 to determine the location of a particular product. For example, a wireless device mounted to the shopping cart 212 (and/or a wireless device of the user) may use RF measurements of radio signals broadcasted by the ESL devices 208 (and/or other nearby ESL devices) to estimate a current location of the shopping cart 212 (and user) within the environment and guide the user to a location 210 of a desired product on the appropriate shelf of gondola 112A.

In some embodiments, the shopping cart 212 may be equipped with an asset tracking tag (e.g., RFID or NFC tag) readable by an appropriate asset tracker of the ESL system installed on one or more of the gondolas 112A and 112B. The gondolas 112A and 112B may correspond to, for example, a region of products available for selection by the user. Such a product region may be any organized area or section within the layout of a retail environment or store that is dedicated to one or more groups or categories of products and merchandise available for selection and purchase by a user. The asset tracking tag in this example may be utilized to detect if the cart 212 has entered or exited the aisle between the gondolas 112A and 112B. In some embodiments, the location of the shopping cart 212 may be estimated based on a combination of RF measurements and information received from the asset tracker identifying the asset tracking tag associated with the cart 212. The RF measurements may be based on, for example, wireless signals exchanged between a wireless device on the cart 212 and an AP (such as AP 106A) of the ESL system.

In some embodiments, the shopping cart 212 may be further equipped with a camera, or any image capturing device, for capturing visual information pertaining to an area of the retail environment in which the shopping cart is located. Visual information captured by the camera on the cart (and/or other nearby cameras, such as one or more shelf cameras and/or OTT cameras) may be used to detect one or more features associated with a surrounding area of the retail environment (e.g., using object detection algorithms or models). The detected features may then be mapped to known locations of one or more ESL devices within the retail environment. The location of the shopping cart 212 may then be estimated based, at least in part, on the known locations of the one or more features. For example, the visual information from the camera(s) may be used to narrow down the location of the shopping cart 212 and/or the location of the user to a particular area or product region of the environment corresponding to a field of view of the camera(s). This may in turn help to improve an accuracy of the location estimates.

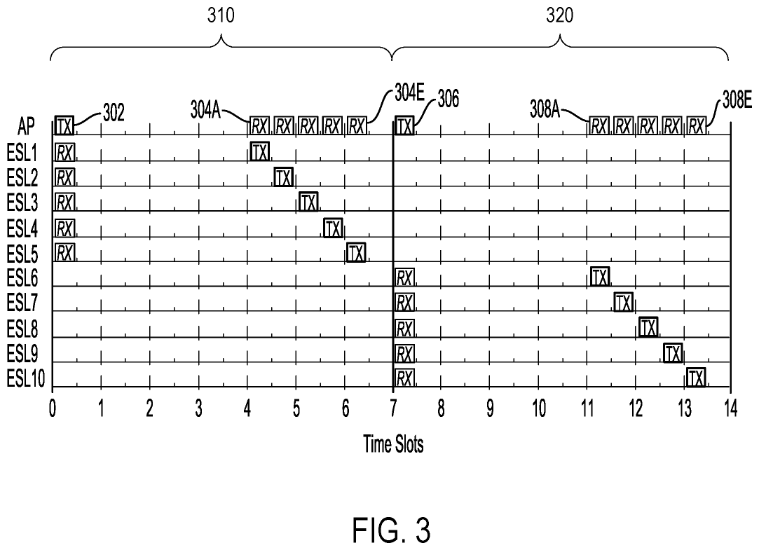

In some embodiments, communication between an AP and the ESL devices of an ESL system, such as between the AP 106A and ESL devices 108A-108D of the ESL system 100 of FIG. 1B, may be performed according to a Time Division Multiple Access (TDMA) scheme, as illustrated in FIG. 3. FIG. 3 is a timing diagram illustrating time division multiplexing for communications between an AP and various ESL devices within an ESL system according to some embodiments of the disclosure. As shown in FIG. 3, an AP and each ESL device of the ESL system may be allocated one of various time periods or slots for transmitting or receiving information. It should be appreciated that a similar TDMA scheme may be used for communications between different ESL devices.

In ESL systems with significant numbers of ESL devices, the ESL devices may be configured to communicate with the AP in different groups, where each group may correspond to a different time frame. For example, a first group of ESL devices (ESL1-ESL5) in FIG. 3 may be configured to communicate with the AP during a first time frame 310, and a second group of ESL devices (ESL6-ESL10) may be configured to communicate with the AP during a second time frame 320. The first and second time frames 310 and 320 may alternate during operation of the wireless network. The AP in this example may transmit or broadcast information that is received by the first group of ESL devices during a first time period (or time slot) 302 in the first time frame 310. The ESL devices in this first group may transmit information to the AP during subsequent time periods/slots in the time frame 310. For example, the first ESL device (ESL1) may transmit information received by the AP during a time period 304A, with the other ESL devices (ESL2-ESL5) in this group transmitting during time periods 304B-304E, respectively, in the time frame 310. Likewise, the AP may transmit information received by the second group of ESL devices during a time period 306 in the second time frame 320. The ESL devices (ESL6-ESL10) in this second group may transmit information received by the AP during respective time periods 308A-308E in the time frame 320.

An ESL device may include components configured together to provide some or all of the functionality described in this disclosure and/or provide additional functionality. FIG. 4 is a block diagram illustrating an example ESL device 400 according to some embodiments of this disclosure. For example, the ESL device 400 may be used to implement each of the ESL devices (including the ESL devices 108A-108D) of the ESL system 100 described above with respect to FIGS. 1A-2B. The ESL device 400 may include a low-power microcontroller 410. Although functionality for the ESL device may be configured by the microcontroller 410 in embodiments of this disclosure, any single or combination of processors (e.g., at least one processor) may be used to perform the functions described according to embodiments of this disclosure.

The microcontroller 410 may include a memory 416. The memory 416 may store computer program code that causes a microprocessor 414 to execute operations that carry out some or all of the functionality described with respect to various embodiments of this disclosure. Although shown as part of the microcontroller 410, the memory 416 may be located internal to or external to the microcontroller 410. The microcontroller 410 may also include one or more wireless radio(s) 412. The wireless radios 412 may include, for example, a Bluetooth wireless radio including a front end that couples to antenna 408 for transmitting and receiving radio frequency (RF) signals at one or more frequencies in one or more frequency bands. In some embodiments, the microcontroller 410 is a System on Chip (SoC) in which two or more components of the wireless radio(s) 412, the microprocessor 414, and/or the memory 416 are included in a single semiconductor package. In some embodiments, the two or more components may be included on a single semiconductor die.

The ESL device 400 may include I/O devices, such as a notification LED 402 and/or an electronic display 404. The notification LED 402 may include one or more light emitting diodes (LEDs), or other light sources configured to flashlight of one or more colors. The notification LED may be triggered to blink at a specific time and/or with a specific color based on a command received from the gateway node 120. For example, a notification LED 402 may blink to attract a user's attention to a particular location on a shelf. The electronic display 404 may be, for example, an electronic-ink (e-Ink) display configured to output the product information.

The ESL device 400 may couple to a battery 406 or other power source to power operations performed by the ESL device 400, such as to operate the wireless radio(s) 412, the notification LED 402, the electronic display 404, the memory 416, and/or the microprocessor 414. The battery 406 may allow placement of the ESL device 400 in a place where constant power supply is difficult. Thus, in order that a single battery charge provides a long period of use (e.g., lasting longer than several years), the ESL device 108 may be configured to reduce power consumption during times when frequent commands are not expected. For example, the ESL device 400 may operate using a wakeup communication scheme. That is, the ESL device 400 wakes up according to predetermined time intervals to determine whether data is waiting to be received. When no data is waiting, power to the ESL device 400 is turned off until the next wakeup period to reduce power consumption. When there is data to be received, the ESL device 400 wakes up to perform communication operations.

It is noted that one or more blocks (or operations) described above with reference to FIGS. 1-4 may be combined with one or more blocks (or operations) described below with reference to one or more of FIGS. 5-7.

FIG. 5 is a signaling diagram of an example communication flow 500 between different devices of an ESL system for enabling cashier-less checkout in a retail environment based on a location of a shopping cart relative to that of a user according to some embodiments of this disclosure. For discussion purposes, communication flow 500 will be described using devices of the ESL system 100 and retail environment of FIG. 1B and FIG. 2B, as described above, but communication flow 500 is not intended to be limited thereto. The devices involved in the communication flow 500 may include, for example, the management server 122, the APs 106A and 106B (“APs 106” collectively), and the BLE device (or “user device”) 124 of a user, as described above with respect to FIG. 1B, along with the shopping cart 212 of FIG. 2B. The user in this example may be a shopper pushing the shopping cart 212 through an aisle between different gondolas (e.g., gondolas 112A and 112B) within the environment while browsing products that are located along the shelves of each gondola and available for purchase by the user. As described above, the shopping cart 212 may be equipped with a wireless device configured to pair with the user device 124 to enable cashier-less checkout by the user.

As shown in the example of FIG. 5, communication flow 500 begins at 502 when the user device 124 pairs with the shopping cart 212 (i.e., pairs with the wireless device associated with the shopping cart 212). In some embodiments, the user device 124 may pair directly with the cart 212, e.g., via an ad-hoc Bluetooth network or piconet established between these devices. Alternatively, the cart 212 may be associated with a unique code (e.g., as provided via a display device mounted on the cart or via a RFID or NFC asset tag), which the user can manually scan with the user device 124 to complete the pairing process. In another example, the user may access cart pairing functionality via an application executable at the user device 124. The application may be, for example, a mobile application associated with the retail store and available for download onto the user device 124 from an online mobile application store. Alternatively, the user may pair the user device 124 with the cart 212 by entering the code and/or other relevant information into a kiosk provided for this purpose, e.g., within a shopping cart area near the entrance of the retail environment. For example, the kiosk may be equipped with a display and a graphical interface that allows the user to request one or multiple carts, which the kiosk may automatically pair with the user device 124. In some implementations, the cart 212 may be a motorized cart that can be directed by the kiosk to the user's location near the kiosk and/or along a predefined path within the environment based on positioning information and/or visual information, as described above.

Once paired, the cart 212 at 504 may transmit a pairing notification to an appropriate one of the APs 106, which in turn may relay the notification to the server 122 at 506. At 508, the server 122 may request location data from the cart 212 and the user device 124 in response to receiving the pairing notification.

At 510, the cart 212 and the user device 124 may transmit the requested location data to the server 122. In some embodiments, the location data from each of the cart 212 and the user device 124 may include RF measurements of wireless signals exchanged between the cart 212, or the user device 124, and the corresponding APs 106 as well as range measurements of wireless signals exchanged between the cart 212 and the user device 124. The RF and/or range measurements may include, for example, a round-trip time (RTT), an angle of arrival (AoA), or a time difference of arrival (TDoA), or any combination of the foregoing.

At 512, the server 122 may use the RF measurements included in the location data received from each of the cart 212 and the user device 124 to estimate the location of each device. The RF measurements may be based on, for example, reference signals exchanged between each of the cart 212 and the user device 124 and a corresponding one of the APs 106. In some implementations, the cart 212 and the user device 124 may use the RF measurements to estimate their own locations, in which case the location data transmitted to the server 122 by each of the cart 212 and the user device 124 includes the corresponding location estimate. In some cases, the pairing notification transmitted by the cart 212 at 504 and received by the server 122 via the APs 106 at 506 may provide the server 212 with an association of the user device 124 with the cart 212 and the estimated location of the user device 124.

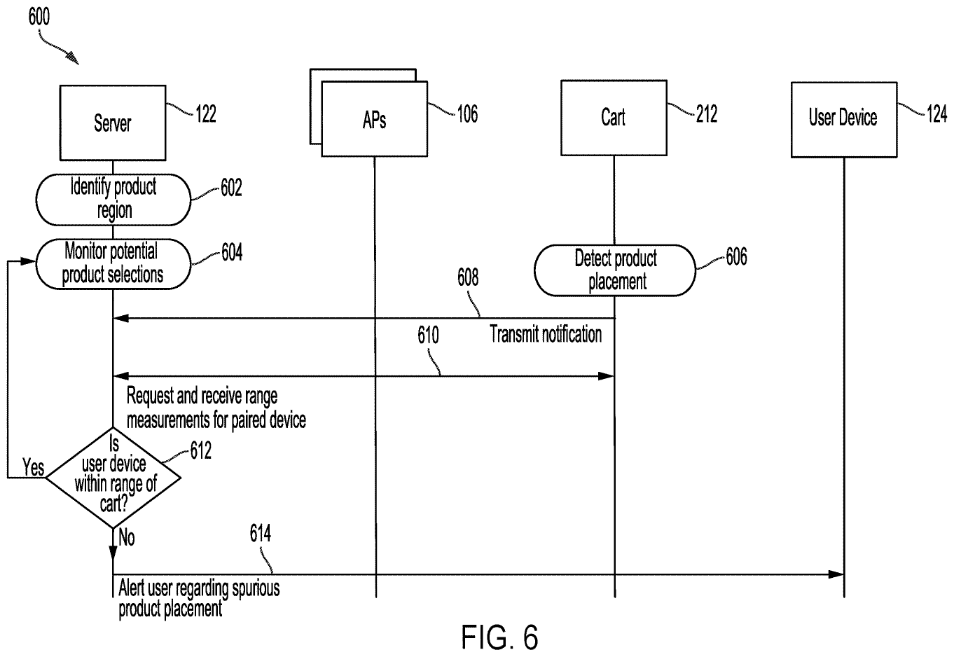

At 514, the server 122 may correlate the estimated location of the cart 212 with that of the user device 124 within the environment. As will be described in further detail below with reference to FIG. 6, the correlated locations of the cart 212 and the user device 124 within the environment may be used to detect one or more events, such as the accidental or spurious placement of an item into the cart (e.g., by another user without knowledge of the user associated with the user device 124).

FIG. 6 is a diagram of an example communication flow 600 between the devices in FIG. 5 for detecting spurious product placement within shopping cart 212 associated with a user of the user device 124 according to some embodiments of this disclosure. Communication flow 600 may represent, for example, a continuation of the communication flow 500 of FIG. 5 described above. Accordingly, the server 122 at 602 may use the correlated locations of the cart 212 and the user device 124 from step 514 of communication flow 500 to identify a product region including various products available for selection by the user in a vicinity of the location of the cart 212 and the location of the user device 124 within the retail environment.

At 604, the server 122 monitors potential product selections by the user in the identified region. For example, the server 122 may activate one or more sensors (e.g., weight sensors, shelf cameras, and/or OTT or surveillance cameras) in the identified region to monitor and detect potential product selections by the user. At 606, the cart 212 may detect the placement of a product into the cart (e.g., using one or more cameras or other sensors mounted on the cart 212, as described above) and transmit a notification of the detected product placement to the server 122 at 608.

Responsive to receiving the notification from the cart 212, the server 122 at 610 may request and receive range measurements for the paired user device 124 from the cart 212. The range measurements may include RF measurements of wireless signals exchanged between the cart 212 and the user device 124. The server 122 may use the range measurements to monitor a distance between the cart 212 and the user device 124 within the retail environment. At 612, the server 122 may determine whether the monitored distance between the location of the user device 124 and the cart 212 is within a threshold distance (e.g., whether the user device 124 is within a threshold range of the cart 212).

If the user device 124 is within range of the cart 212, then it may be assumed that the product was placed by the user associated with the user device 124. However, if the user device 124 is determined to be located further away than the threshold distance from the cart 212 (i.e., not within range of the cart 212), it may be assumed that the product detected at 606 was not placed by the actual user of the user device 124. Accordingly, the server 122 at 614 may send an alert to the user device 124 indicating the detection of a spurious product placement into the cart 212. In some embodiments, the server 122 may return to steps 602 and 604 to identify a second region of products available for selection by the user in the vicinity of the user device 124 and monitor potential product selections by the user by activating one or more sensors in the second region.

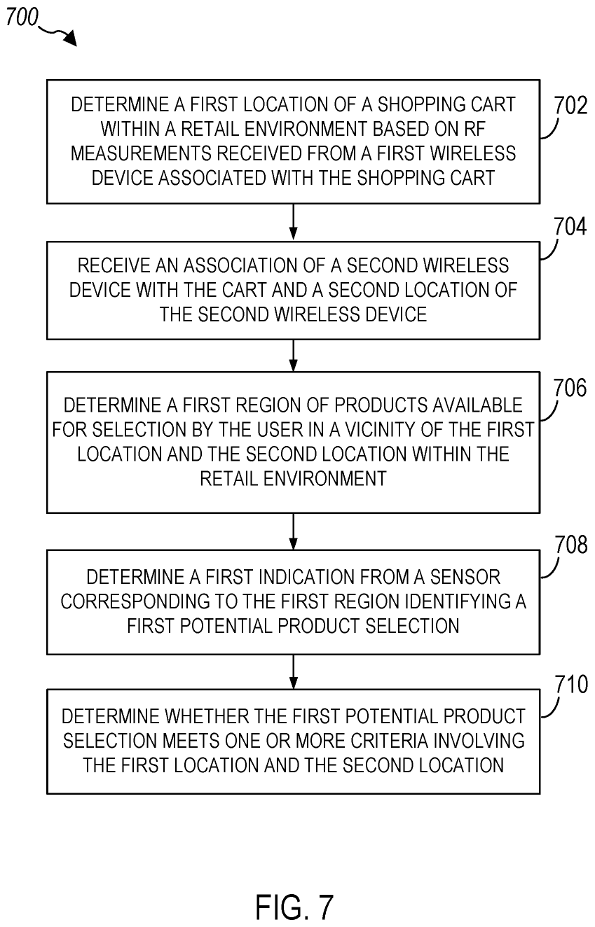

FIG. 7 is a flow chart of an example method 700 for enabling cashier-less checkout in a retail environment according to some embodiments of this disclosure. For discussion purposes, method 700 will be described using the ESL system 100 of FIG. 1B, as described above. For example, the method 700 including the operations described below may be performed by the management server 122 or the gateway node 120 of the ESL system 100, as described above.

Method 700 begins at block 702, which includes determining a first location of a shopping cart within a retail environment, based on RF measurements received via a wirefrom a first wireless device associated with the shopping cart. For example, the RF measurements may be received by the management server 122 of FIG. 1B via a wireless network and associated infrastructure (e.g., relayed to the server by an AP of the infrastructure, such as AP 106A of FIG. 1B, as described above).

At block 704, a second wireless device may be associated with the shopping cart and a second location of the second wireless device determined. The association may be made by correlating the first location with a second location of a second wireless device associated with a user of the shopping cart. For example, the second wireless device may be paired, such as through a personal area network, to the shopping cart. The second location may be determined based on additional RF measurements received by the management server 122 via the wireless network from the second wireless device. Alternatively, the second location may be received from the first wireless device or the second wireless device after either device determines its location using, for example, the additional RF measurements, global positioning system (GPS) measurements, or other techniques.

At block 706, a first region of products available for selection by the user in a vicinity of the first location within the retail environment may be determined. The first region may be determined based on information stored in a database accessible by the management server 122, either stored in the management server 122 or on another server available to the management server 122. The database may store, for example, a listing of shelfs and their locations in the retail environment and products stored on the shelves. The first location may be used to lookup shelfs and products in the vicinity of the first location.

One or more sensors within the first region may be activated to detect potential product selections by the user. The first region may include, for example, a plurality of product shelves and the one or more sensors may include at least one of a surveillance camera having a field of view covering the first region or a weight sensor installed on each product shelf in the first region.

At block 708, a first indication from one or more sensors may be received identifying a first potential product selection from the shelves.

At block 710, it may be determined whether the first potential product selection meets one or more criteria involving the first location and the second location. For example, the first potential product selection of the first indication may be validated by comparing the location of the first potential product selection with the first location and the second location. When the three locations are within a threshold range of each other, the potential product selection may be validated as the identification of the product selected by the user. The selection of a first product by the user in the first region may be detected based on information received from the one or more sensors activated at block 708.

In one or more aspects, techniques for supporting ESL systems may include additional aspects, such as any single aspect or any combination of aspects described below or in connection with one or more other processes or devices described elsewhere herein. In a first aspect, a method comprises: determining, by a server, a first location of a cart within an environment based on radio frequency (RF) measurements received via a wireless network from a first wireless device associated with the cart; receiving, by the server via the wireless network, an association of a second wireless device with the cart and a second location of the second wireless device; determining, by the server, a first group of products associated with a first region of the environment in a vicinity of the first location; determining, by the server, a first indication from a sensor corresponding to the first region, the first indication identifying a first potential product selection; and determining, by the server, whether the first potential product selection meets one or more criteria involving the first location and the second location.

In a second aspect, in combination with the first aspect, the first region comprises a product shelf, and the sensor comprises at least one of a surveillance camera having a field of view at least partially covering the first region or a weight sensor associated with the product shelf in the first region.

In a third aspect, in combination with one or more of the first aspect or the second aspect, determining whether the first potential product selection meets one or more criteria comprises determining the first potential product selection is valid based on a distance between the first location and the second location not exceeding a threshold distance.

In a fourth aspect, in combination with one or more of the first aspect through the third aspect, the method further comprises: determining that the second location is further than the threshold distance from the first location; determining, when the second location is further than the threshold distance from the first location, a second region of products available for selection in a vicinity of the second location; and determining, by the server, a second indication from a second sensor corresponding to the second region, the second indication identifying a second potential product selection.

In a fifth aspect, in combination with one or more of the first aspect through the fourth aspect, determining whether the first potential product selection meets one or more criteria involving the first location and the second location comprises receiving an indication from the first wireless device regarding a distance between the first location and the second location based on range measurements of wireless signals exchanged between the first wireless device and the second wireless device.

In a sixth aspect, in combination with one or more of the first aspect through the fifth aspect, the method further comprises: receiving, by the server, a notification from the first wireless device regarding placement of a product into the cart as detected by a camera; and responsive to the notification, transmitting an alert to the second wireless device indicating the product placed into the cart.

In a seventh aspect, in combination with one or more of the first aspect through the sixth aspect, the wireless network includes access points associated with an Electronic Shelf Label (ESL) system of the environment, wherein the ESL system includes a plurality of ESL devices deployed in different product regions throughout the environment, and wherein the first location of the cart is determined based on the RF measurements of wireless signals exchanged between the first wireless device and one or more of the access points.

In an eighth aspect, in combination with one or more of the first aspect through the seventh aspect, the cart is equipped with an asset tracking tag readable by an asset tracker of the ESL system, wherein the first location of the cart is estimated based on a combination of the RF measurements and information received from the asset tracker identifying the asset tracking tag.

In a ninth aspect, in combination with one or more of the first aspect through the eighth aspect, the cart is equipped with a camera for capturing visual information pertaining to an area of the environment in which the cart is located, and determining the first location of the cart comprises: receiving the visual information captured by the camera from the first wireless device associated with the cart; determining one or more features associated with the area of the environment based on the received visual information; determining locations of one or more ESL devices based on the one or more features; and determining the first location of the cart based, at least in part, on the locations of the one or more features.

In a tenth aspect, in combination with one or more of the first aspect through the ninth aspect, the wireless network is at least one of a WiFi network, a Bluetooth Low Energy (BLE) network, or an ultra-wideband (UWB) network, wherein the RF measurements comprise at least one of a round-trip time (RTT), an angle of arrival (AoA), or a time difference of arrival (TDoA).

In an eleventh aspect, an apparatus includes a memory storing processor-readable code and at least one processor coupled to the memory, wherein the at least one processor configured to execute the processor-readable code to cause the at least one processor to perform operations comprising: determining a first location of a cart within an environment based on radio frequency (RF) measurements received via a wireless network from a first wireless device associated with the cart; receiving, via the wireless network, an association of a second wireless device with the cart and a second location of the second wireless device; determining a first group of products associated with a first region of the environment in a vicinity of the first location; determining a first indication from a sensor corresponding to the first region, the first indication identifying a first potential product selection; and determining whether the first potential product selection meets one or more criteria involving the first location and the second location.

In a twelfth aspect, in combination with the eleventh aspect, the first region comprises a product shelf, wherein the sensor comprises at least one of a surveillance camera having a field of view at least partially covering the first region or a weight sensor associated with the product shelf in the first region.

In a thirteenth aspect, in combination with one or more of the eleventh aspect or the twelfth aspect, the operations for determining whether the first potential product selection meets one or more criteria comprise determining the first potential product selection is valid based on a distance between the first location and the second location not exceeding a threshold distance.

In a fourteenth aspect, in combination with one or more of the eleventh aspect through the thirteenth aspect, the operations further comprise: determining that the second location is further than the threshold distance from the first location; determining, when the second location is further than the threshold distance from the first location, a second region of products available for selection in a vicinity of the second location; and determining a second indication from a second sensor corresponding to the second region, the second indication identifying a second potential product selection.

In a fifteenth aspect, in combination with one or more of the eleventh aspect through the fourteenth aspect, the operations for determining whether the first potential product selection meets one or more criteria involving the first location and the second location comprise receiving an indication from the first wireless device regarding a distance between the first location and the second location based on range measurements of wireless signals exchanged between the first wireless device and the second wireless device.

In a sixteenth aspect, in combination with one or more of the eleventh aspect through the fifteenth aspect, the operations further comprise: receiving a notification from the first wireless device regarding placement of a product into the cart as detected by a camera; and responsive to the notification, transmitting an alert to the second wireless device indicating the product placed into the cart.

In a seventeenth aspect, in combination with one or more of the eleventh aspect through the sixteenth aspect, the wireless network includes access points associated with an Electronic Shelf Label (ESL) system of the environment, wherein the ESL system includes a plurality of ESL devices deployed in different product regions throughout the environment, and wherein the first location of the cart is determined based on the RF measurements of wireless signals exchanged between the first wireless device and one or more of the access points.

In an eighteenth aspect, in combination with one or more of the eleventh aspect through the seventeenth aspect, the cart is equipped with an asset tracking tag readable by an asset tracker of the ESL system, and wherein the first location of the cart is estimated based on a combination of the RF measurements and information received from the asset tracker identifying the asset tracking tag.

In a nineteenth aspect, in combination with one or more of the eleventh aspect through the eighteenth aspect, the cart is equipped with a camera for capturing visual information pertaining to an area of the environment in which the cart is located, wherein the operations for determining the first location of the cart comprise: receiving the visual information captured by the camera from the first wireless device associated with the cart; determining one or more features associated with the area of the environment based on the received visual information; determining locations of one or more ESL devices based on the one or more features; and determining the first location of the cart based, at least in part, on the locations of the one or more features.

In a twentieth aspect, in combination with one or more of the eleventh aspect through the nineteenth aspect, the wireless network is at least one of a WiFi network, a Bluetooth Low Energy (BLE) network, or an ultra-wideband (UWB) network, and wherein the RF measurements comprise at least one of a round-trip time (RTT), an angle of arrival (AoA), or a time difference of arrival (TDoA).

In a twenty-first aspect, an apparatus includes an at least partially enclosed volume to hold products selected by a user, and a first wireless device including a memory and at least one processor coupled to the memory, wherein the at least one processor is configured to perform operations comprising: determining a first location of the first wireless device based on radio frequency (RF) measurements of wireless signals exchanged between the first wireless device and one or more access points of a wireless network; determining a second location of a second wireless device associated with the user, based on additional RF measurements of signals exchanged between the first wireless device and the second wireless device; and transmitting, to a server via the wireless network, the first location of the first wireless device, an association of the second wireless device with the first wireless device, and the second location of the second wireless device.

In a twenty-second aspect, in combination with the twenty-first aspect, the operations further comprise: determining a distance between the first location and the second location based on range measurements of the signals exchanged between the first wireless device and the second wireless device; and transmitting, to the server via the wireless network, an indication of the distance.

In a twenty-third aspect, in combination with one or more of the twenty-first aspect or the twenty-second aspect, the apparatus further comprises a camera to detect products placed into the at least partially enclosed volume, wherein the operations further comprise: receiving an indication from the camera regarding placement of a product into the at least partially enclosed volume; and transmitting, to the server via the wireless network, a notification regarding the product placed into the at least partially enclosed volume as detected by the camera.

In a twenty-fourth aspect, in combination with one or more of the twenty-first aspect through the twenty-third aspect, the operations further comprise: transmitting, to the server via the wireless network, visual information captured by the camera for an area corresponding to the first location.

In a twenty-fifth aspect, in combination with one or more of the twenty-first aspect through the twenty-fourth aspect, the apparatus further comprises an asset tracker to read an asset tag associated with the product placed into the at least partially enclosed volume, wherein the notification transmitted to the server includes information identifying the product based on the asset tag read by the asset tracker.

In a twenty-sixth aspect, in combination with one or more of the twenty-first aspect through the twenty-fifth aspect, the one or more access points are associated with an Electronic Shelf Label (ESL) system, and wherein the ESL system includes a plurality of ESL devices deployed in different product regions.

In a twenty-seventh aspect, an apparatus includes at least one processor and a memory coupled to the at least one processor, wherein the at least one processor is configured to perform operations including: determining a first location of a user based on radio frequency (RF) measurements of wireless signals received from one or more access points of a wireless network; determining a second location of a cart, based on additional RF measurements of signals received from a wireless device associated with the cart; and transmitting, to a server via the wireless network, the first location of the user in association with the second location of the cart.

In a twenty-eighth aspect, in combination with the twenty-seventh aspect, the operations further comprise: receiving, from a user via a user interface, a pairing request to pair with the wireless device associated with the cart; and establishing an association with the wireless device of the cart based on the pairing request received from the user.

In a twenty-ninth aspect, in combination with one or more of the twenty-seventh aspect or the twenty-eighth aspect, the operations further comprise: determining a distance between the first location and the second location based on range measurements of the signals received from the wireless device associated with the cart; and transmitting, to the server via the wireless network, an indication of the distance.

In a thirtieth aspect, in combination with one or more of the twenty-seventh aspect through the twenty-ninth aspect, the one or more access points are associated with an Electronic Shelf Label (ESL) system, wherein the ESL system includes a plurality of ESL devices deployed in different product regions.

Components, the functional blocks, and the modules described herein with respect to the figures described above include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel

1. A method comprising:
determining, by a server, a first location of a cart within an environment based on radio frequency (RF) measurements received via a wireless network from a first wireless device associated with the cart;
receiving, by the server via the wireless network, an association of a second wireless device with the cart and a second location of the second wireless device;
determining, by the server, a first group of products associated with a first region of the environment in a vicinity of the first location;
determining, by the server, a first indication from a sensor corresponding to the first region, the first indication identifying a first potential product selection; and
determining, by the server, whether the first potential product selection meets one or more criteria involving the first location and the second location.

2. The method of claim 1, wherein the first region comprises a product shelf, and wherein the sensor comprises at least one of a surveillance camera having a field of view at least partially covering the first region or a weight sensor associated with the product shelf in the first region.

3. The method of claim 1, wherein determining whether the first potential product selection meets one or more criteria comprises determining the first potential product selection is valid based on a distance between the first location and the second location not exceeding a threshold distance.

4. The method of claim 3, further comprising:
determining that the second location is further than the threshold distance from the first location;
determining, when the second location is further than the threshold distance from the first location, a second region of products available for selection in a vicinity of the second location; and
determining, by the server, a second indication from a second sensor corresponding to the second region, the second indication identifying a second potential product selection.

5. The method of claim 4, wherein determining whether the first potential product selection meets one or more criteria involving the first location and the second location comprises receiving an indication from the first wireless device regarding a distance between the first location and the second location based on range measurements of wireless signals exchanged between the first wireless device and the second wireless device.

6. The method of claim 3, further comprising:
receiving, by the server, a notification from the first wireless device regarding placement of a product into the cart as detected by a camera; and
responsive to the notification, transmitting an alert to the second wireless device indicating the product placed into the cart.

7. The method of claim 1, wherein the wireless network includes access points associated with an Electronic Shelf Label (ESL) system of the environment, wherein the ESL system includes a plurality of ESL devices deployed in different product regions throughout the environment, and wherein the first location of the cart is determined based on the RF measurements of wireless signals exchanged between the first wireless device and one or more of the access points.

8-10. (canceled)

11. An apparatus, comprising:
a memory storing processor-readable code; and
at least one processor coupled to the memory, the at least one processor configured to execute the processor-readable code to cause the at least one processor to perform operations comprising:
determining a first location of a cart within an environment based on radio frequency (RF) measurements received via a wireless network from a first wireless device associated with the cart;
receiving, via the wireless network, an association of a second wireless device with the cart and a second location of the second wireless device;
determining a first group of products associated with a first region of the environment in a vicinity of the first location;
determining a first indication from a sensor corresponding to the first region, the first indication identifying a first potential product selection; and
determining whether the first potential product selection meets one or more criteria involving the first location and the second location.

12. The apparatus of claim 11, wherein the first region comprises a product shelf, and wherein the sensor comprises at least one of a surveillance camera having a field of view at least partially covering the first region or a weight sensor associated with the product shelf in the first region.

13. The apparatus of claim 11, wherein the operations for determining whether the first potential product selection meets one or more criteria comprise determining the first potential product selection is valid based on a distance between the first location and the second location not exceeding a threshold distance.

14. The apparatus of claim 13, wherein the operations further comprise:
determining that the second location is further than the threshold distance from the first location;
determining, when the second location is further than the threshold distance from the first location, a second region of products available for selection in a vicinity of the second location; and
determining a second indication from a second sensor corresponding to the second region, the second indication identifying a second potential product selection.

15. (canceled)

16. The apparatus of claim 13, wherein the operations further comprise:
receiving a notification from the first wireless device regarding placement of a product into the cart as detected by a camera; and
responsive to the notification, transmitting an alert to the second wireless device indicating the product placed into the cart.

17. The apparatus of claim 11, wherein the wireless network includes access points associated with an Electronic Shelf Label (ESL) system of the environment, wherein the ESL system includes a plurality of ESL devices deployed in different product regions throughout the environment, and wherein the first location of the cart is determined based on the RF measurements of wireless signals exchanged between the first wireless device and one or more of the access points.

18. The apparatus of claim 17, wherein the cart is equipped with an asset tracking tag readable by an asset tracker of the ESL system, and wherein the first location of the cart is estimated based on a combination of the RF measurements and information received from the asset tracker identifying the asset tracking tag.

19. The apparatus of claim 17, wherein the cart is equipped with a camera for capturing visual information pertaining to an area of the environment in which the cart is located, and wherein the operations for determining the first location of the cart comprise:
receiving the visual information captured by the camera from the first wireless device associated with the cart;
determining one or more features associated with the area of the environment based on the received visual information;
determining locations of one or more ESL devices based on the one or more features; and
determining the first location of the cart based, at least in part, on the locations of the one or more features.

20. The apparatus of claim 17, wherein the wireless network is at least one of a WiFi network, a Bluetooth Low Energy (BLE) network, or an ultra-wideband (UWB) network, and wherein the RF measurements comprise at least one of a round-trip time (RTT), an angle of arrival (AoA), or a time difference of arrival (TDoA).

21-26. (canceled)

27. An apparatus comprising:
a memory and at least one processor coupled to the memory, the at least one processor configured to perform operations comprising:
determining a first location of a user based on radio frequency (RF) measurements of wireless signals received from one or more access points of a wireless network;
determining a second location of a cart, based on additional RF measurements of signals received from a wireless device associated with the cart; and
transmitting, to a server via the wireless network, the first location of the user in association with the second location of the cart.

28. The apparatus of claim 27, wherein the operations further comprise:
receiving, from a user via a user interface, a pairing request to pair with the wireless device associated with the cart; and
establishing an association with the wireless device of the cart based on the pairing request received from the user.

29. The apparatus of claim 28, wherein the operations further comprise:
determining a distance between the first location and the second location based on range measurements of the signals received from the wireless device associated with the cart; and
transmitting, to the server via the wireless network, an indication of the distance.

30. The apparatus of claim 27, wherein the one or more access points are associated with an Electronic Shelf Label (ESL) system, and wherein the ESL system includes a plurality of ESL devices deployed in different product regions.
